(19) United States
(12) Patent Application Publication
(10) Pub. No.: US 2013/0160317 A1
(43) Pub. Date: Jun. 27, 2013

(54) VENT DRYER STAND

(71) Applicant: Palmo Stumpo, Hamilton (CA)

(72) Inventor: Palmo Stumpo, Hamilton (CA)

(21) Appl. No.: 13/693,204

(22) Filed: Dec. 4, 2012

Related U.S. Application Data
(60) Provisional application No. 61/578,577, filed on Dec. 21, 2011.

(51) Int. Cl. F26B 25/00

(52) U.S. Cl. CPC F26B 25/00
USPC 34/239

(57) ABSTRACT

A vent dryer stand for insertion into a floor mounted vent outlet includes a base which includes a support housing for contacting the floor and supporting the vent dryer stand; the base includes an inserted portion for insertion into the vent outlet, the inserted portion defining an inlet for receiving air from the vent outlet. The vent dryer stand also includes air conduits in fluid communication with the base for receiving air from the base and distributing the air to outlet orifices.

The present application claims priority from regularly filed U.S. provisional patent application 61/578,577 filed on Dec. 21, 2011 under the title Vent Dryer Stand by Palmo Stumpo.

### FIELD OF THE INVENTION

This invention relates to apparatus for drying wet or damp clothing, footwear and headwear and more particularly this invention relates to apparatus for drying wet or damp equipment that is used for sporting activities such as basketball, football and hockey.

### BACKGROUND OF THE INVENTION

There are prior art arrangements which are known for drying clothing and headwear and footwear as well as sports equipment one of which is described in U.S. Pat. No. 5,632,099 issued May 27, 1997 under the title Apparatus for Drying Footwear by Seifert et al. This is a freestanding device which is simply placed over the register of a heating vent. There is no structure which would ensure that the device does not tip over and is held in the upright position other than gravity and the footprint of the base.

### SUMMARY OF THE INVENTION

The present device is a vent dryer stand which can be plugged into a vent outlet which is located in the floors and normally covered over by a register. To use the present device one would simply remove the existing floor register and plug the base of the vent dryer stand into the vent outlet.

### BRIEF DESCRIPTION OF THE DRAWINGS

The present device will now be described by way of example only with reference to the following drawings in which:

FIG. 1 is a schematic side elevational view of a vent dryer stand.

FIG. 2 is a cross sectional schematic elevational view of the vent dryer stand shown in FIG. 1 depicting the flow of air with arrows.

FIG. 3 is a schematic perspective view of the vent dryer stand shown in FIG. 1.

FIG. 4 is schematic perspective top view of the base portion of the vent dryer stand shown in FIG. 1.

FIG. 5 is a schematic perspective inverted view of the base portion of the vent dryer as shown in FIG. 1.

FIG. 6 is a schematic cross sectional view of the base portion of the vent dryer stand deployed within a vent outlet which is mounted in the floor.

FIG. 7 is a top perspective schematic view of the base portion of the vent dryer stand deployed within the vent outlet.

FIG. 8 is a perspective schematic view of an alternate embodiment of the vent dryer stand having a modified base.

FIG. 9 is a perspective schematic alternate embodiment of the vent dryer stand having a modified base.

FIG. 10 is a schematic side elevational view of the vent dryer stand shown in FIG. 1 together with some sports equipment mounted thereon.

FIG. 11 is schematic perspective view of the vent dryer stand shown in FIG. 1 together with some sports equipment and clothing mounted thereon.

FIG. 12 is a front perspective schematic alternate embodiment of the vent dryer stand showing a modified configuration.

FIG. 13 is a rear perspective schematic view of the alternate embodiment of the vent dryer stand shown in FIG. 12.

### DETAILED DESCRIPTION OF THE PREFERRED EMBODIMENTS

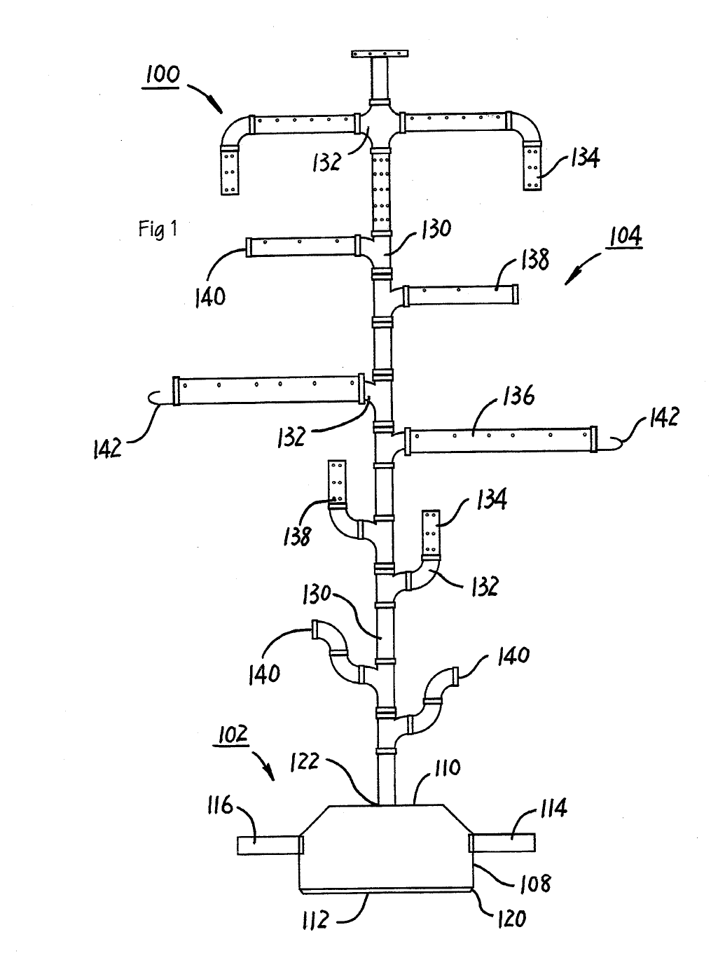

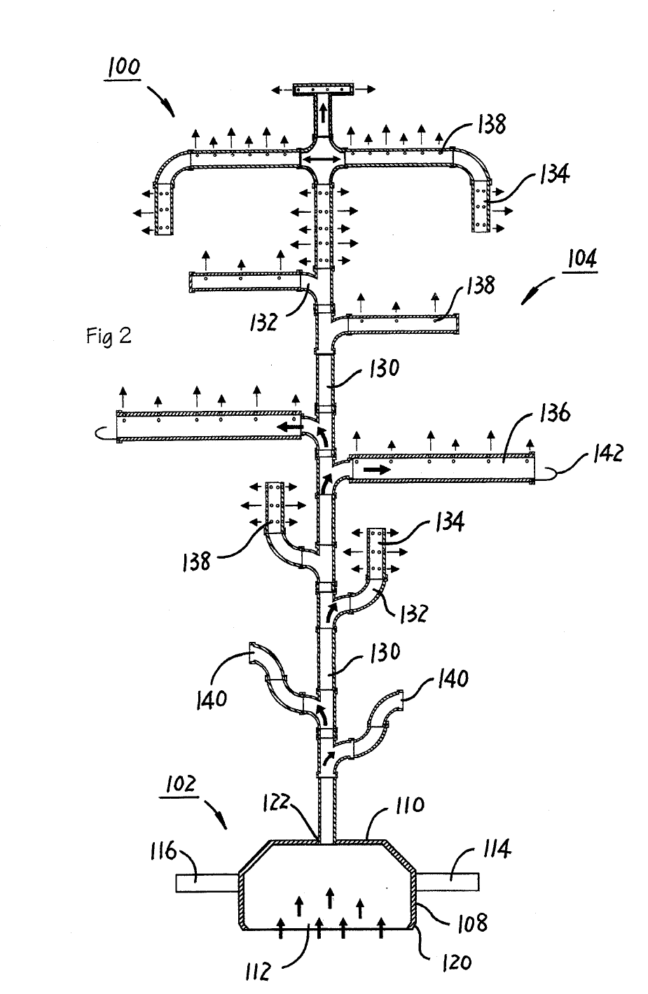

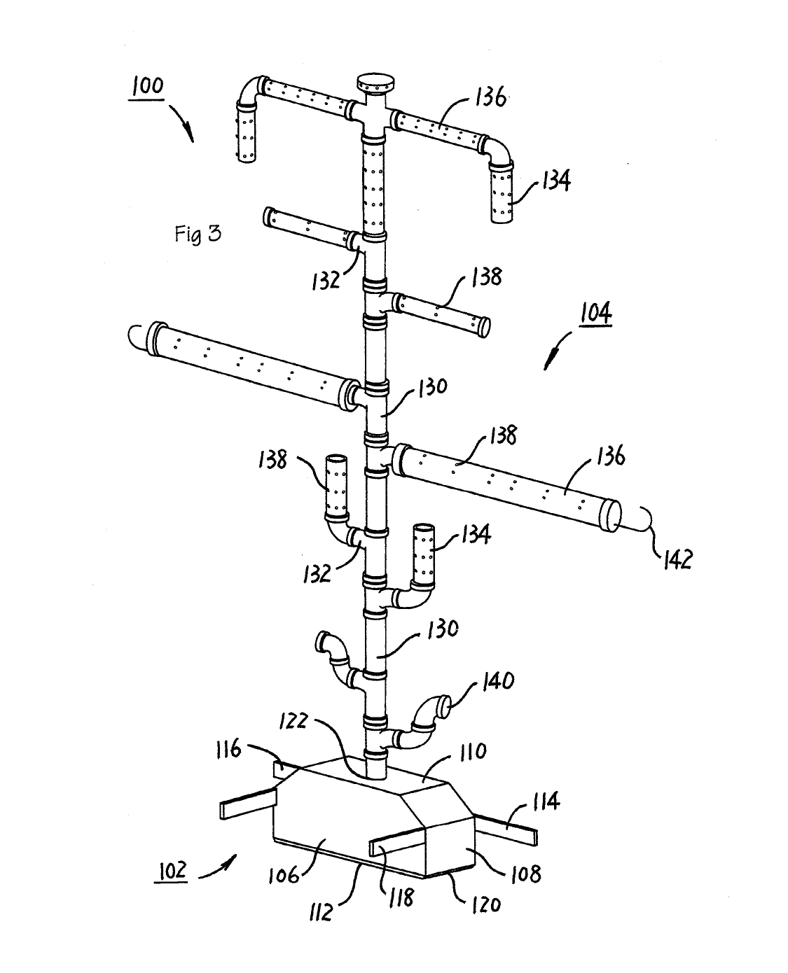

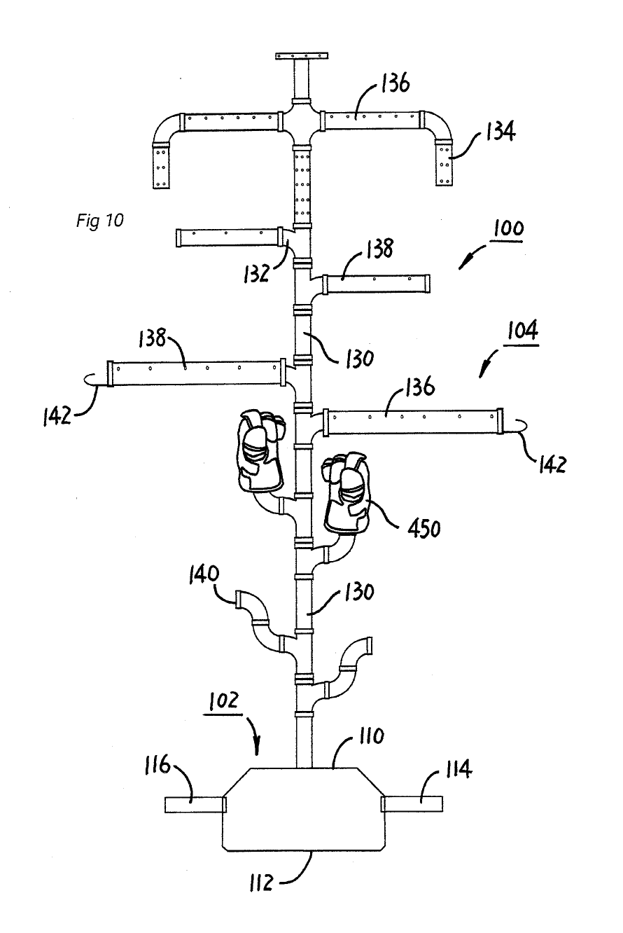

The present device vent dryer stand 100 is depicted in FIGS. 1 through 3 as well as in FIGS. 10 & 11.

Vent dryer stand 100 includes the following major component namely base 102 and air conduits 104.

Base 102 includes the following components, namely side walls 106, end walls 108, a top wall 110 and an inlet 112.

Base 102 further includes a right end arm 114, a left end arm 116, forward side arms 118 and an optionally rearward side arms which are not shown in the drawings however would be mounted such that they project rearwardly and perpendicular to a rear side wall of base 102.

Base 102 further includes a tapered portion 120 as well as an outlet 122.

Air conduits 104 include a central conduit 130 having branch conduits 132 emanating therefrom which include vertical dryer portions 134 and horizontal portions 136.

Air conduits 104 further includes air orifices 138 as well as vents 140.

Optionally air conduits 104 may also include hooks 142.

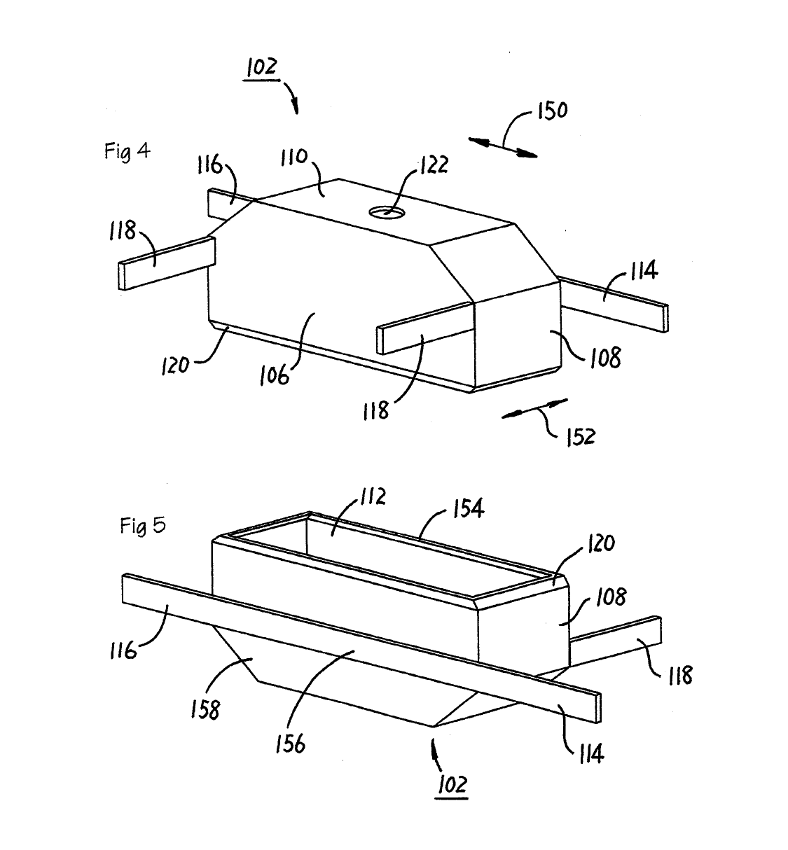

Referring now to FIGS. 4 & 5 base 102 is aligned along the longitudinal direction 150 as shown by the arrows and along a transverse direction 152 also shown by the arrows.

The forward side arms 118 are mounted parallel to the transverse direction 152 and the right and left end arms 114 and 116 are respectively mounted along the longitudinal direction 150.

FIG. 5 shows base 102 in an inverted position. The walls define an inlet 112 which includes a tapered portion 120 extending along inlet periphery 154.

Looking at the back side wall 158 we can see that right end arm 114 and left end arm 116 actually is one continuous end arm 156.

A person skilled in the art will note that it is possible that the end arms 114 and 116 are either individual arms or one continuous and contiguous length as shown as end arm 156.

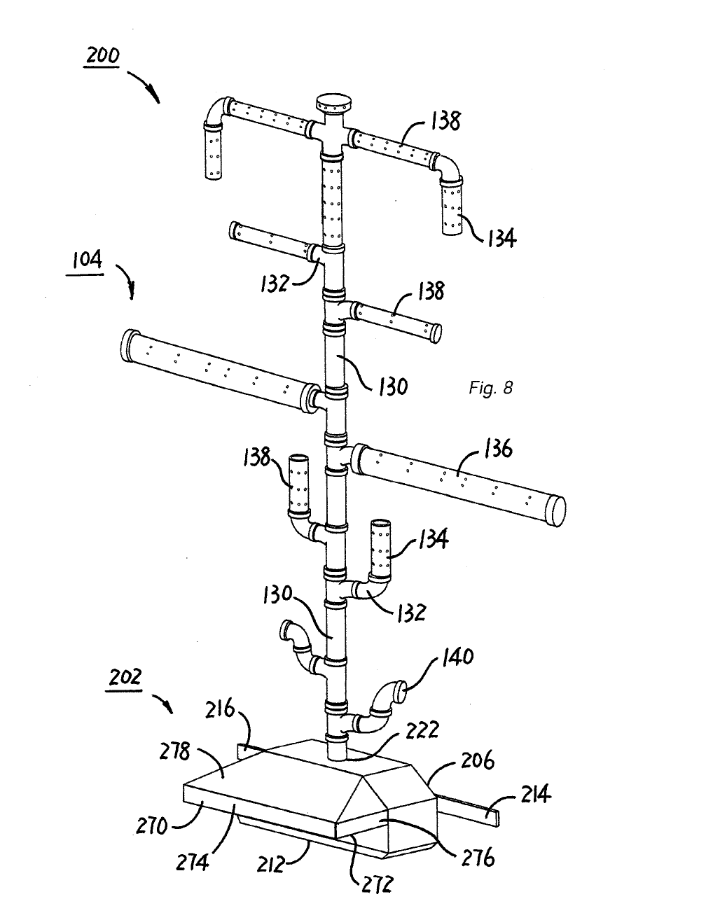

Referring now to FIG. 8 an alternate embodiment namely vent dryer stand 200 which includes a base 202 and air conduits 104.

Base 202 includes right end arms 214 and left end arms 216 which are similar to right end arm 114 and left end arm 116 of the previous embodiment namely vent dryer stand 100.

Base 202 however further includes a forward side shoulder 270 which includes a support surface 272, a shoulder side 274, a shoulder end 276 and a shoulder top 278.

In most other aspects base 202 is similar in construction to base 102 and includes an inlet 212 which is similar to inlet 112 and an outlet 222 which is similar to outlet 122.

Forward side shoulder 270 replaces the forward side arms 118 for supporting the vent dryer stand 200.

Optionally and not depicted in the drawings vent dryer stand 200 may include a rearward side shoulder which would project in identical fashion from the back side wall 206.

In all other aspects vent dryer stand 200 is similar to vent dryer stand 100 and includes similar air conduits 104.

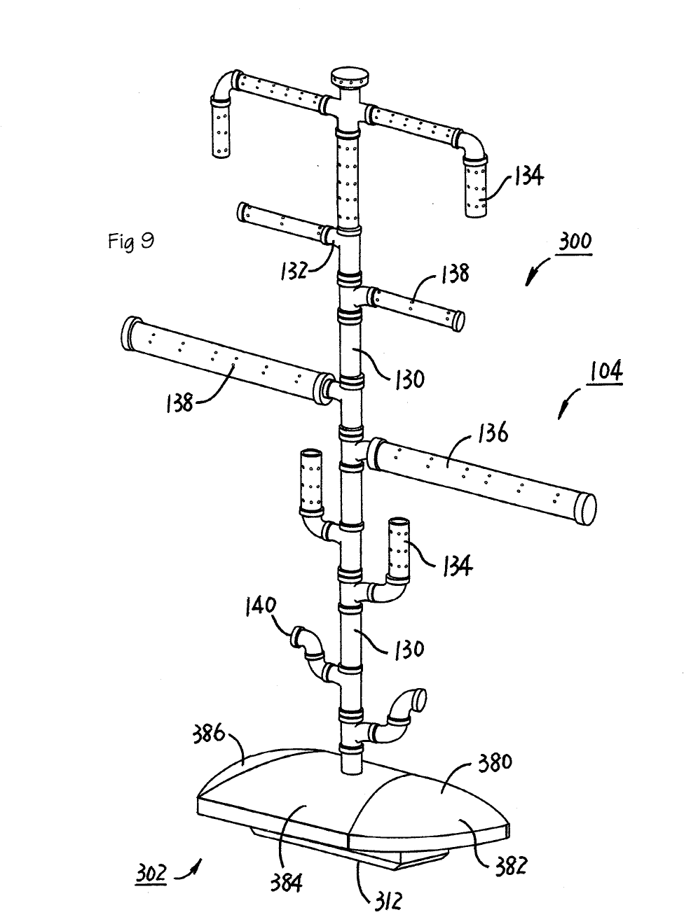

Referring now to FIG. 9 another alternate embodiment namely vent dryer stand 300 includes a base 302 and air conduits 104.

Base 302 includes a support housing 380 which includes a right end housing 382, a left end housing 386 and a forward side housing 384.

In all other aspects base 302 is similar to base 102 including an inlet 312 which is similar to inlet 112.

Optionally but not depicted support housing 380 may include a rearward side housing which projects rearwardly in similar fashion as forward side housing 384 projects forwardly.

### In Use

Referring now to FIGS. 6, 7, 10 & 11, FIG. 6 shows schematically base 102 deployed within a vent outlet 408 which is mounted onto a floor 402 which includes a subfloor 404 and is supported by joists 406.

Vent outlet 408 normally terminates at the end of duct work 420 and normally has an air register not shown deployed within vent outlet 408.

In order to use vent dryer stand 100 one would have to remove the vent register not shown and plug in inserted portion 190 of base 102 into the top portion of vent outlet 408. Until such time as the right end arm 114, left end arm 116 as well as the forward side arms 118 make contact with the top portion of floor 402.

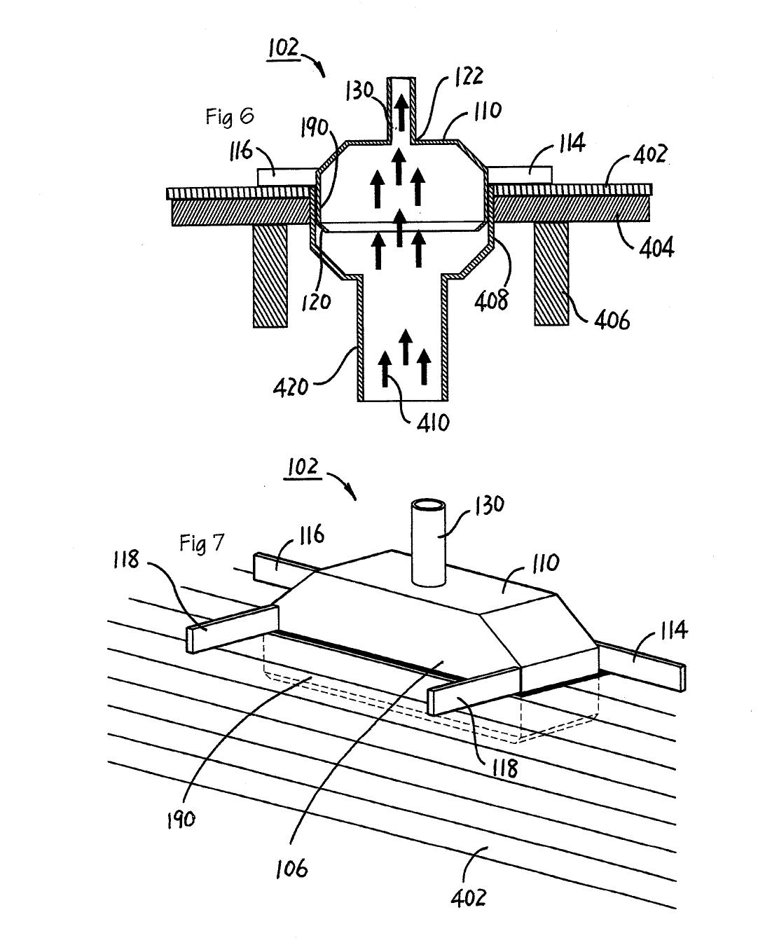

Referring now to FIG. 7 the reader will note that the inserted portion 190 of base 102 is shown in dashed lines beneath the surface of floor 402.

Vent dryer stand 100 normally does not include rearward projecting side arms since the location of the vent outlet 408 normally is very close to adjacent to a wall.

Therefore there is no danger of the vent dryer stand 100 tipping and/or tilting backward since there would be a wall there to support it.

There are however right end arms 114 and left end arm 116 as well forward side arms 118 to prevent the vent dryer stand 100 from tipping forwardly and/or left and/or right out of the vent outlet 408.

FIGS. 10 & 11 depicted schematically how various pieces of equipment including gloves 450, shirts 452, ice skates 454, pants 456, leg pads 458, shoulder pads 460 and helmets 462 could be mounted onto air conduits 104 of vent dryer stand 100.

### DESCRIPTION OF ALTERNATE EMBODIMENT

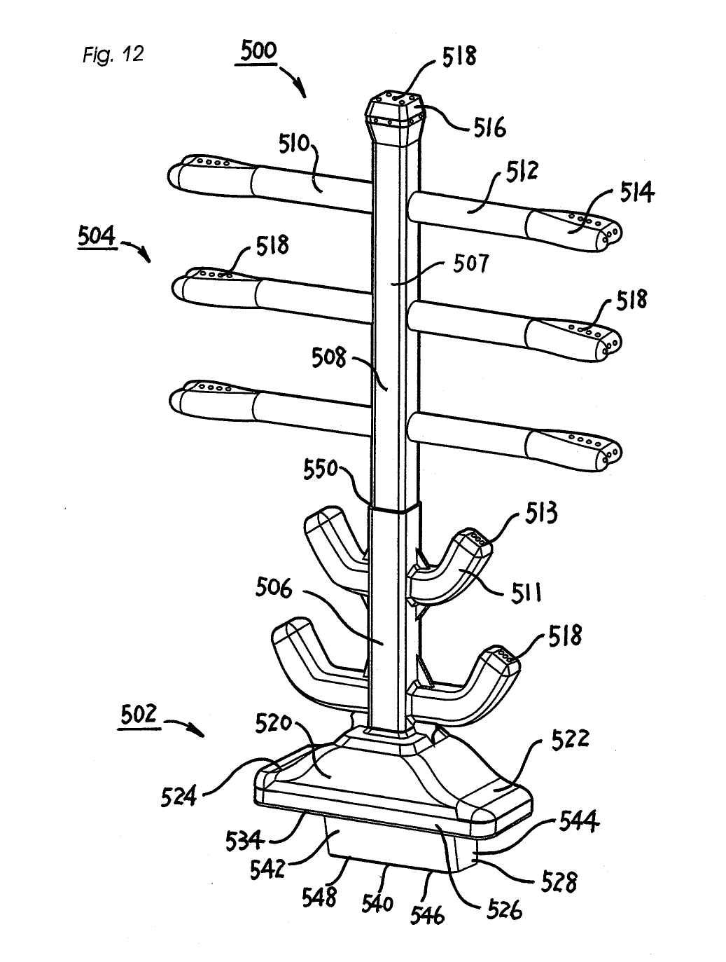

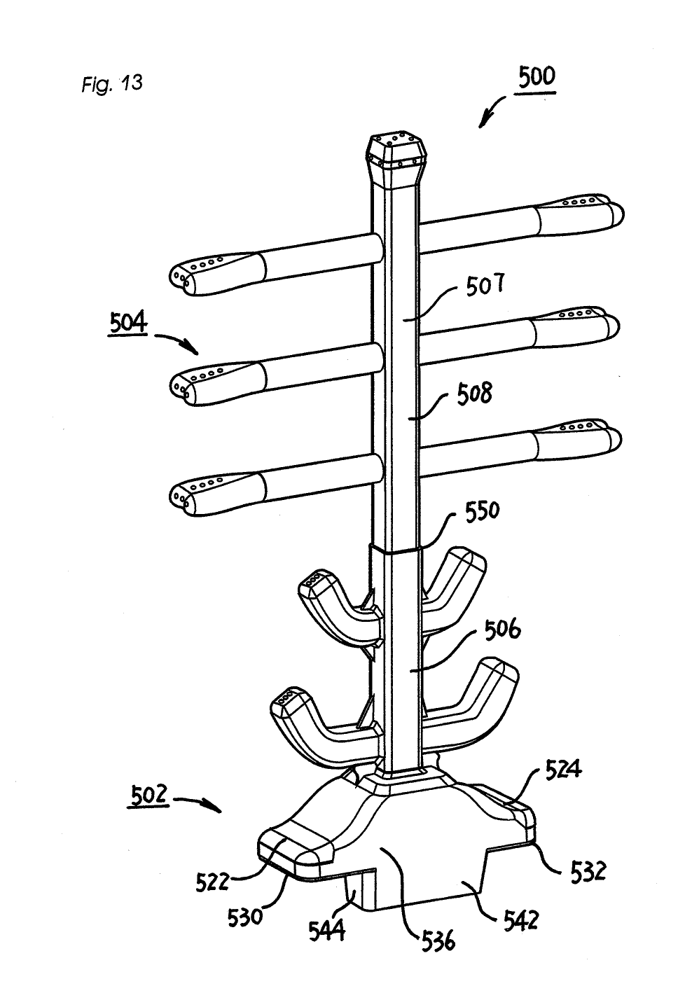

Referring now to FIGS. 12 and 13 which are to be interpreted in conjunction with FIGS. 4 and 5 an alternate embodiment of the present invention vent dryer stand shown generally as 500 includes the following major components namely a base 502, air conduits 504 which include a central vertical conduit 507 preferably including a lower central conduit 506, an upper central conduit 508, horizontal arms 510 and curved arms 511.

Horizontal arms 510 include a horizontal conduit 512 and terminate at a nozzle 514 having orifices defined therein 518.

Curved arms 511 also include a nozzle 513 and orifices 518.

Upper central conduit 508 is telescopically and slideably received within lower central conduit 506 at insertion point 505 therefore the central vertical conduit 507 is comprised of two pieces namely lower central conduit 506 and upper central conduit 508. Upper central conduit 508 terminates in the top nozzle 516 also having orifices 518.

Referring now to base 502 in FIGS. 12 and 13 base 502 includes a support housing 520 which includes a right shoulder 522, a left shoulder 524 and a front shoulder 526. These shoulders define a right support surface 530 corresponding to right shoulder 522, a left support surface 532 corresponding to left shoulder 524 and a front support surface 534 corresponding to front shoulder 526.

Base 502 also includes an inserted portion 528 which includes side walls 542, end walls 544 and defines an inlet 540 having an inlet periphery 548. Support housing 520 also includes a rear wall 536 as shown in FIG. 13.

Within support housing 520 there is a duct which essentially is the same as base 102 without the addition of the arms 114, 116 and 118, in other words the duct is equivalent to base 102 without the arms as depicted in FIGS. 4 and 5. The duct shown as base 102 in FIGS. 4 and 5 includes all of the components depicted in FIGS. 4 and 5 wherein the inserted portion 528 is equivalent to the inserted portion 190 and wherein the other portions of base 102 are shrouded or hidden underneath of support housing 520. Duct not shown also includes an outlet 122, a top wall 110 not shown in FIGS. 12 and 13.

### In Use

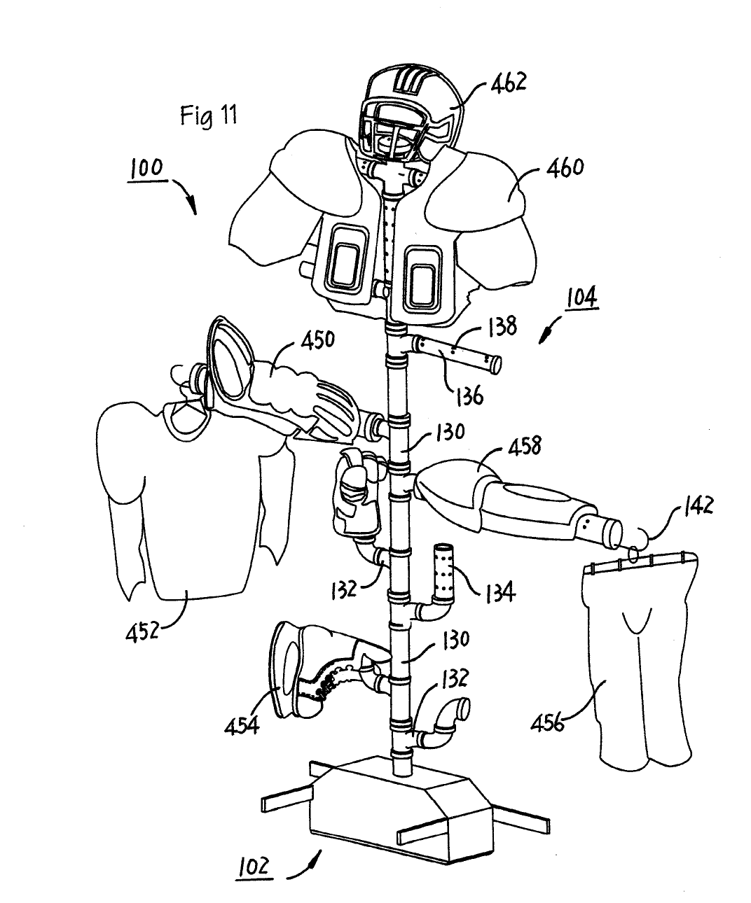

In use the above described embodiment shown in FIGS. 12 and 13 functions in almost identical fashion to the embodiments described and shown in FIGS. 1 through 11 and particularly includes the base 102 shown in FIGS. 4 and 5 most of which is hidden underneath of a support housing 520 and the insertion of inserted portion 528 is similar to that depicted in FIGS. 6 and 7 with the exception that there are no arms 114, 116 and 118 which instead have been replaced with right shoulder 522, left shoulder 524 and front shoulder 526 which define right support surface 530, left support surface 532 and front support surface 534.

Additionally the shape and design of the horizontal arms as well as the curved arms differs from the previous embodiments however they are functionally very similar if not identical. The central conduit is split into two conduits namely lower central conduit 506 and upper central conduit 508 which are telescopically slideably engaged with one another.

Referring to FIG. 6 the inserted portion 528 inserts into vent outlet 408 as depicted in FIG. 6 in very similar if not identical fashion.

The difference would be that rather than right arm 114 and left arm 116 contacting floor 402 right support surface 530 and left support surface 532 would be contacting floor 402 as well as front support surface 534.

It should be apparent to persons skilled in the arts that various modifications and adaptation of this structure described above are possible without departure from the spirit of the invention the scope of which defined in the appended claim.

1. A vent dryer stand for insertion into a floor mounted vent outlet comprises;
a) a base which includes a support housing for contacting the floor and supporting the vent dryer stand;
b) the base includes an inserted portion for insertion into the vent outlet, the inserted portion defining an inlet for receiving air from the vent outlet;
c) air conduits in fluid communication with the base for receiving air from the base and distributing the air to outlet orifices.

2. The vent dryer stand claimed in claim 1 wherein the support housing further includes a right shoulder, a left shoulder and a front shoulder for supporting the vent dryer stand.

3. The vent dryer stand claimed in claim 1 wherein the support housing further including a left support surface corresponding to the left shoulder, a right support surface corresponding to the left shoulder and a front support surface corresponding to a front shoulder.

4. The vent dryer stand claimed in claim 1 wherein the inserted portion includes side walls and end walls and is dimensioned to slidably be received within vent outlet.

5. The vent dryer stand claimed in claim 1 wherein the air conduits including a central vertical conduit which includes a lower central conduit in fluid communication with the base at one end, and at the other end attached to an upper central conduit for communicating air vertically upwardly.

6. The vent dryer stand claimed in claim 5 wherein the upper central conduit is telescopically and slidably mounted into the lower central conduit.

7. The vent dryer stand claimed in claim 5 wherein the air conduits further include horizontal arms and curved arms, each attached at on end to the central vertical conduit and at the other end terminating at a nozzle and including orifices for discharging air.

8. The vent dryer stand claimed in claim 1 wherein the base includes a duct within the support housing and integrally part of the base for receiving air from the vent outlet and communicating the air to the air conduits.

9. The vent dryer stand claimed in claim 4 wherein the inserted portion includes end walls and side walls that terminate in a tapered portion for ease of insertion of the inserted portion into the vent outlet.
